(19) United States
(12) Patent Application Publication
(10) Pub. No.: US 2003/0041108 A1
(43) Pub. Date: Feb. 27, 2003

(54) Enhancement of communications by peer-to-peer collaborative web browsing

(76) Inventors: Robert F. Henrick, Basking Ridge, NJ (US); Tzyh-Jong Wang, Edison, NJ (US)

Correspondence Address: PENNIE AND EDMONDS, 1155 AVENUE OF THE AMERICAS, NEW YORK, NY, 100362711

(21) Appl. No.: 09/935,218

(22) Filed: Aug. 22, 2001

(51) Int. Cl. G06F 15/16

(52) U.S. Cl. 709/205; 709/218

(57) ABSTRACT

A system and method are disclosed for enhancing a conversation initiated over the Internet, Public Switched Telephone Network (PSTN), wireless cellular or data networks, or other communication medium by adding peer-to-peer collaborative Internet browsing to the conversation. In a preferred embodiment, the present system comprises a Web server used to set up a collaborative browsing session where each participant enters a common session name and user identity and client software components resident on the devices of each session participant. Each client software component comprises a monitoring module that is adapted to analyze HTTP requests from a first participant's browser and generate a set of instructions that is transmitted to other participants' devices to duplicate the first participant's browsing experience for the other participants. In some preferred embodiments, the present system may be integrated with a variety of network services to provide further value to participants and enhance the collaborative browsing session.

### FIELD OF THE INVENTION

The present invention relates to the enhancement of communications, and in particular to utilizing peer-to-peer collaborative browsing to enhance one-on-one or group communications.

### BACKGROUND OF THE INVENTION

One phenomenon attributable to the Internet has been the explosion of communications between individuals and groups through a variety of now established means. E-mail is a commonplace part of people's lives, and is used both for extended and quick-response messaging. Instant messaging allows people to both advertise their availability to communicate and then use real-time text messaging to do so. Chatrooms are both places for idea exchange and social gatherings. The ease and low cost of Internet messaging has made interpersonal communication one of the most frequent and popular uses of the Internet. It has led to the creation of groups and communities who's principal, and at times only, communication media is the Internet. These groups and communities take advantage of the Internet's unique capability to create one-to-many communications at very low cost.

But to date, these groups have been centered around text messaging and sharing Internet material by sending files or cutting and pasting Web page universal resource locators (URLs). The simplicity of being able to type and read in a window allows rapid use of such systems, but limits the depth of the communication.

By contrast, most person-to-person voice communication still occurs over the Public Switched Telephone Network (PSTN). Although a highly personal and immediate medium, voice is limited in transferring information. For example, a real estate agent describing a house is clearly limited by the voice medium. Given the proliferation of Internet-enabled computers in the office and home, many of these conversations occur with both parties near a computer, but without using the computer as part of the communication.

The Internet is a very visually-oriented and media-rich environment. Most Internet content is accessed with a PC and browser such as Microsoft's Internet Explorer.™ Individuals typically have favorite sites that reflect professional interest or personal tastes. Many individuals create their own Web pages. Educators often keep a series of content sites that are valuable in their programs. Merchants often maintain sites that highlight and sell their products, or provide customers with services or information. These sites, however, are not well linked with other communication media such as e-mail, instant messaging, and the PSTN.

More sophisticated environments allowing richer communication are being created. Collaboration programs such as Lotus Sametime™ or Microsoft Netmeeting™ allow users to come together and share discussions with communication features including chat, audio, and video. Services such as eRoom™ technology create shared spaces and environments where people can work as teams, and add workflow management and shared storage to the Internet communication space. A key feature in many of these programs is application sharing, where any application on one desktop can be viewed by another person or group on their desktops, and, with the first desktop user's permission, edited by those people. This capability is achieved by replicating the bitmap from the first user's computer to the group and, for joint work, capturing the mouse and keyboard movements on any group member's computer and sending them to the application running on the first user's computer.

The flexibility of sharing applications is enormous, but comes at a price. Each participant must download a large client, join a new group or convey addresses manually, and have a machine with certain capabilities. The entire group may require significant bandwidth for transmission of the bitmap image to all participants, particularly if any animation (e.g., a Macromedia Flash™ or Shockwave™ animation) or video is displayed that requires the bitmap to be continually updated. The bandwidth requirements, requirements to have multiple clients downloaded and installed for each communication system, and the need to learn and remember multiple complex interfaces, make these systems difficult to use, and hence have limited their adoption.

The e-commerce world has addressed these issues in the context of collaborative sales support by restricting the capability to share applications to pushing browser windows. For example, U.S. Pat. No. 6,177,932 to Galdes et al. discloses an Internet call center for use by e-commerce merchants. In the system disclosed by Galdes et al., a visitor to an e-commerce Web site can request personal help which causes a call-center agent to contact the user via phone or via a chat program that is part of the call-center system and integrated with the Web site. The call-center agent can then send pages to a small program that pushes these pages to the user's browser. Instead of a bitmap, a call-center agent can send an appropriate URL and instructions to a small program downloaded from the site and installed on the visitor's computer that instructs the visitor's browser to go to a specific Web page and assemble the relevant content.

The integration of such systems with call-center software and an e-commerce site provides high value to customer engagement. However, it requires new hardware and software at these centers, typically a push server, and therefore represents a major expense for the call center. Moreover, this approach can only engage customers who have initially contacted the call center through the Web, and is not available to sessions initiated with inbound voice calls. It is also a one-way-only push, so that customers cannot lead the discussion on the Web, nor can other people join the session (e.g., a technical specialist). Call-center agents are also typically limited to a set of pages relevant to the company site.

Other prospects have tried to generalize the push capability to be independent of the merchant's site. For example, U.S. Pat. No. 5,944,791 to Scherpler discloses a centralized control server that processes desired pages and reserves them to a “pilot” in control and “passengers” who follow. The centralized server is responsible for reformatting pages and, as a result, the system can use a thin client but requires highly centralized overhead and exhibits large server demand.

U.S. Pat. No. 6,199,096 to Mirashrafi et al. proposes a more symmetric and lower load system in which users communicate through a centralized server designated as a bridgepoint that coordinates redistribution of URLs to all participants. But the simple URL transmission described by Mirashrafi et al. does not work in many modern Web pages, which have embedded frames, tabs, and other sub-page features, as described in more detail below.

Moreover, the fact that these models require a centralized server to be involved throughout the user conversation has several drawbacks. First, a continual role in messaging or processing presents serious scalability issues and causes increased latency, as well as increasing the cost of a large-scale system. Second, the privacy of the individual users is compromised because the server has access to all shared Web pages and conversations. Third, when designed as standalone systems, these systems ignore the wealth of existing chat, instant messaging, and group discussions available on the Web, as well as voice and short message channels in other communications networks that already exist. Finally, reliance on a centralized server during the conversation leads to a single point of failure or congestion during the user session due to hardware or software failure or network congestion between server and a user.

### SUMMARY OF THE INVENTION

A system and method are disclosed for enhancing a conversation initiated over the Internet, Public Switched Telephone Network (PSTN), wireless cellular or data networks, or other communication medium by adding collaborative Internet browsing to the conversation. In a preferred embodiment, the present system comprises a Web server used to set up a collaborative browsing session and client software components resident on the devices of each session participant. Each client software component comprises a monitoring module that is adapted to analyze HTTP requests from a first participant's browser and generate a set of instructions that is transmitted to other participants' devices to replicate the first participant's browsing experience for the other participants.

Because the system utilizes peer-to-peer communication between participants' devices to conduct the collaborative browsing session, the Web server is needed only during initial session setup. This makes the present system easily scalable and robust to failure. In addition, the privacy of users is guaranteed because the server is not at all engaged in the user's conversation. Moreover, by enabling users to use their existing browsers to conduct the collaborative session, the system can be easily used with no learning curve.

In some preferred embodiments, the present system may be integrated with a variety of network services to provide further value to participants and enhance the collaborative browsing session.

### BRIEF DESCRIPTION OF THE DRAWINGS

These and other aspects of the invention will be better appreciated when taken in conjunction with the detailed description and accompanying drawings, in which:

FIG. 1 is a block diagram of a preferred embodiment of a system for enhancing communications with collaborative browsing;

FIG. 2 is a flowchart depicting a preferred embodiment for establishing and conducting a collaborative browsing session with two participants;

FIG. 3 is a flow chart depicting a preferred embodiment for analyzing HTTP requests;

FIG. 4 is a flowchart depicting a preferred embodiment of system operation when a third participant joins a collaborative browsing session;

FIG. 5 shows a preferred embodiment of a personalized Web page from which one may initiate or join a collaborative browsing session;

FIG. 6 shows a preferred embodiment of a Web page displaying links to “public” sessions that may be joined by any interested party;

FIG. 7 is a block diagram of a preferred embodiment of a system for supporting participants in a collaborative browsing session on different sides of a firewall;

FIG. 8 is a block diagram of a preferred embodiment of a system for supporting content filtering to limit the Web sites accessible during a collaborative browsing session; and

FIG. 9 is a flow chart depicting a preferred embodiment of system operation in which participants to a collaborative browsing session may synchronously view streaming media.

### DETAILED DESCRIPTION OF THE PREFERRED EMBODIMENTS

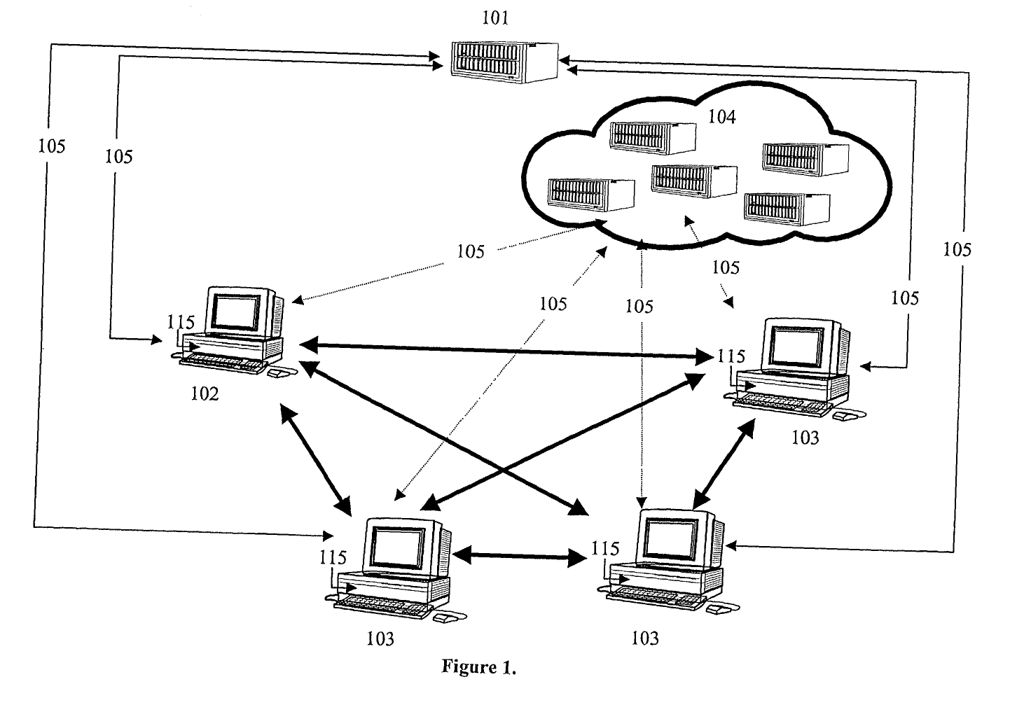

A preferred embodiment of a system for enabling collaborative browsing between participants to a collaborative-browsing session is shown in FIG. 1. As shown in FIG. 1, the system preferably comprises a server 101, an originating participant device 102, one or more other participant devices 103, and a series of Web sites 104 accessible via the open Internet or a closed IP network such as a corporate Intranet. Each participant device 102, 103 preferably comprises a browser adapted to access server 101 and Web sites 104 via independent paths 105 using standard Internet protocols. Users of participant devices 102, 103 are hereafter sometimes referred to as participants because they participate in the collaborative browsing session, as described in more detail below.

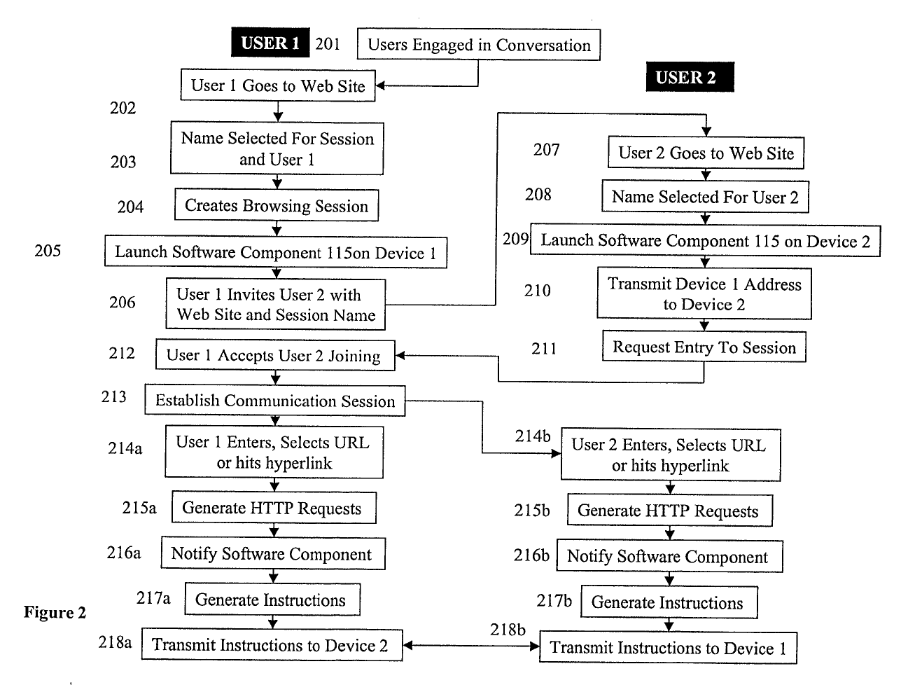

A preferred embodiment of system operation in which a collaborative session is established between originating participant 102 and one additional participant 103 is now described in connection with FIG. 2. For ease of description, originating participant device 102 will be referred to as device 1 and participant device 103 will be referred to as device 2 during the following description. In addition, the participant using device 1 will be referred to as user 1 and the participant using device 2 will be referred to as user 2 during the following description.

For purposes of this preferred embodiment, it is assumed that user 1 and user 2 are or have been engaged in a conversation by some communication means before establishing a collaborative browsing session (step 201 in FIG. 2). This conversation may be conducted via e-mail, instant messaging (e.g., AOL's ICQ™), PSTN or cellular telephone, cell-phone short message service (SMS), a paging system, a chat room session on an e-commerce site, or any other two-way communication.

In step 202, user 1 enters an appropriate URL into his or her browser to connect to system server 101. In step 203, a Web page is delivered to device 1 that includes (1) a first field for user 1 to enter a name or other identifier for the collaborative browsing session, and (2) a second field for user 1 to enter a name that will be used to identify the user during the session. User 1 selects and enters a session name and username which are then transmitted by device 1 to server 101.

In step 204, server 101 creates a browsing session with the specified name. In step 205, server 101 transmits a message that causes a software component 115 to be launched on device 1. Software component 115 facilitates various aspects of system operation described in more detail below, including opening a joint browsing window, monitoring user browsing, managing communication with other session participants 103, communicating with other session participants to synchronize browsing, automatically retrieving Web material to follow a browsing session, and informing server 101 when a collaborative session ends. If software component 115 is not already resident on device 1, it is automatically downloaded from server 101 and installed on device 1.

Software component 115 may preferably be instantiated as a browser plug-in, a Microsoft ActiveX component, or other software component that is downloaded and installed on the participant device. It runs throughout the collaborative session and is adapted to interface with an API exposed by the device browser to provide window management and URL monitoring of other windows, in particular the window in which the joint browsing of the collaborative session is occurring. In a preferred embodiment, the user does not interact directly with software component 115, except when the component alerts the user that a participant has joined or left the collaborative session. In alternative embodiments, the functionality provided by software component 115 may be built into the user's browser or other appropriate software application running on device 1.

In step 206, user 1 invites another participant (i.e., user 2, in this example) to participate in the collaborative session he or she has established, and provides user 2 with the session name and URL of server 101. This information may be communicated via any suitable communication means, such as the communication means listed above and used in step 201.

In step 207, user 2 enters server 101's URL into his or her browser. In step 208, a Web page is delivered to device 2 that includes (1) a first field for user 2 to enter the session name, and (2) a second field for user 2 to enter a name that will be used to identify the user during the session. User 2 enters the session name and selects and enters a username for himself or herself which are then transmitted by device 2 to server 101.

In step 209, server 101 transmits a message that causes a second instance of software component 115 to be launched on device 2. If software component 115 is not already resident on device 2, it is automatically downloaded from server 101 and installed on device 2. In step 210, server 101 transmits the IP address of device 1 to device 2.

In step 211, device 2 transmits a message to device 1 requesting entry into the collaborative browsing session. Device 2 includes its username for the session in this request so that user 1 can determine whether he or she wishes to permit user 2 to join the collaborative session. In step 212, if user 1 is willing to let user 2 join the session, user 1 replies to this request message with his or her own username, so that user 2 can confirm that he or she requested entry to the correct collaborative browsing session. In step 213, device 1 and device 2 establish a communication session that will be used to carry messages between the devices, as described in more detail below. The communication session is preferably established using a TCP/IP or UDP socket or other suitable connection.

At this point, collaborative browsing may begin. Throughout the collaborative browsing session, either user 1 or user 2 may request Internet content by, for example, entering a URL or selecting a hyperlink, as illustrated in step 214 (a and b). (For ease of discussion, the user who requested the content will hereafter be referred to as the requesting user or requesting participant.) To satisfy the requesting user's request, the user's browser generates one or more HTTP requests (step 215), as described in more detail below.

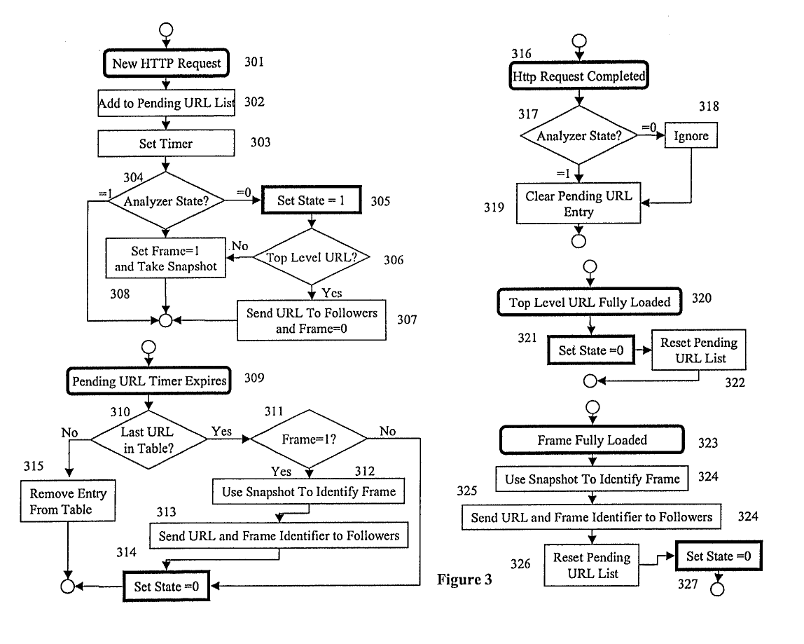

As each HTTP request is created, the requesting user's browser passes a request notification to a monitoring module of software component 115 via the browser's API (step 216). The monitoring module analyzes the HTTP requests identified in the request notifications and generates a set of instructions for the non-requesting user's device that will duplicate the requesting user's Web experience for the non-requesting user (step 217). This analysis is described in more detail in connection with FIG. 3 below. In step 218, the set of instructions generated by the monitoring module are transmitted to software component 115 running on the non-requesting user's device. The instructions are then passed to the non-requesting user's browser to recreate the requesting user's Web experience for the non-requesting user. Steps 214 to 218 are repeated each time either session participant requests Web content.

As will be recognized from the above discussion, server 101 plays a role only during session set up but has no involvement with communications between participants in the collaborative session itself. In addition, in this preferred embodiment, server 101 retains only the session identifier and the address of device 1 to enable additional parties to join, thereby reducing server load and preserving privacy of the session participants.

Before describing a preferred embodiment of a monitoring module for analyzing HTTP requests, a brief overview of the need for such a module is provided. Modem Web pages comprise a series of embedded URLs that independently retrieve information from one or more sites. Common usage of frames may mean that the top level URL remains unchanged, while a significant part of the page does not. It is also possible to have frames embedded in frames. Uses of embedded URLs in scripts can load certain segments. The result of selecting a URL may not change the page at all, but spawn a new browser window that is the focus of the URL selection. Consequently, joint browsing that simply passes top-level URLs as suggested by Mirashrafi et al. will not succeed in creating an identical Web experience for each session participant. To address this problem, each device in the present system is adapted to analyze its own Web clickstreams and formulate instructions to other devices participating in the session that enable those other devices to duplicate a first participant's Web experience for other participants in a collaborative browsing session.

In a preferred embodiment, the monitoring module forms part of software component 115 and is designed to interface with the API exposed by Internet Explorer. Alternatively, when the participant device runs a different browser, a suitable API and a companion plug-in may be written for the browser if one does not already exist. In yet another embodiment, if the browser running on the participant's device is Netscape Navigator (or other browser that complies with the Netscape plug-in standard) a plug-in may be launched that opens an Internet Explorer window within the browser. This provides access to the usual Explorer API. In still another alternative embodiment, suitable software for providing the monitoring functionality may be built into the browser itself or may be included in another suitable software application running on the participant device.

A preferred embodiment of the functionality provided by the monitoring module of software component 115 is now described in connection with FIG. 3. As shown in FIG. 3, and described in more detail below, the module preferably defines a state machine whose state is a function of detected browser actions and timers set by the module itself. The small circles in FIG. 3 represent the state machine at rest, awaiting a new event. The machine is initially initialized to state=0.

A first type of event that may occur is generation of an HTTP request by the device browser. Just before the browser transmits the HTTP request, it notifies the monitoring module via the browser API that a request is about to be made (step 301). The notification includes the URL that is the subject of the request and a “dispatch interface pointer,” described in more detail below.

In step 302, the URL that is the subject of the request is added to a list of outstanding URL requests that have been made by the browser. In step 303, a timer is set for the URL that specifies an expiration time after which the monitoring module will assume that the URL is “broken.” A “broken” URL is one that does not result in a response from the Web server to which the HTTP request was directed.

In a preferred embodiment, the expiration time is preferably calculated using an algorithm that takes into account both the average and standard deviation of the time required to complete an HTTP request. In addition, the algorithm may initially use a fixed time (e.g., 10 seconds) as the expiration time until an adequate number of HTTP requests have been processed so that a meaningful average can be calculated. Thus, for example, the system may initially set the expiration time for requested URLs as:

expiration time=10 seconds

Thereafter, the monitoring component preferably monitors the amount of time required to complete HTTP requests during the collaborative session. Once a statistically meaningful number of requests have been completed, the monitoring component dynamically calculates the average time and standard deviation to complete a request and sets the expiration time for subsequent URLs as:

expiration time=average time+one standard deviation

In addition, if desired, the algorithm may include a fixed maximum time (e.g., 10 seconds) above which the timer may not be set even if the average time for completing requests exceeds this amount.

Returning to FIG. 3, in step 304, the monitoring module determines whether the browser is in the process of retrieving a page (state=1) or not (state=0). In step 305, if the HTTP request initiates a new page (state=0), the state machine is changed to state=1.

In step 306, the monitoring module determines whether or not the requested URL is a top-level URL by examining the “dispatch interface pointer” in the request notification provided by the browser API. Although not generally known by those skilled in the art, it is the case with the Internet Explorer API that the “dispatch interface pointer” is always the same (during the lifetime of a browser instance), if the requested URL is the top-level URL in a page.

In step 307, if the URL requested is a top-level URL, a frame flag is set to 0 and the URL is sent to all session participants even as the requesting browser is making the request via the Internet (recall that the notification to the monitoring component via the API occurs before the request is made by the browser). Since most HTTP requests are for top-level URLs rather than for just a frame that covers part of the browser screen, this technique allows the original requester and the other session participants to load and view the requested page at nearly the same time.

Although, as noted, the monitoring module can determine from the request notification if the request originates in the top-level or in a subframe, when the request is for a subframe, the monitoring module cannot determine from the notification the specific subframe that is the subject of the request. Consequently, in step 308, when the request originates in a subframe, a frame flag is set to 1 and the monitoring module takes a snapshot of the frame structure that will allow it to determine the subframe from which the request originated by comparing the snapshot to a second snapshot of the frame structure taken after the request is completed, as described below. The state machine then returns to rest.

A second type of event that may occur is the expiration of a pending URL timer, as shown in step 309. This typically occurs due to a broken URL, where the Web site that received the HTTP request has a coding error that results in an incomplete page. In step 310, the monitoring module determines whether or not the URL that was the subject of the request was the last URL in the URL table. If not, processing proceeds to step 315, described below. If the URL was the last URL in the table, the page can be considered complete, the browser is instructed to stop all pending URL requests, and processing continues with step 311 where the monitoring component determines whether the request was for a frame (frame=1) or a top-level URL (frame=0).

If the original request was for a top-level URL, then processing proceeds to step 314, described below. If the original request was for a frame, then, in step 312, a new snapshot of the page's frame structure is taken and compared to the snapshot taken in step 308 to identify the highest-level frame that has changed. In step 313, the URL from this highest-level frame and its frame identifier are transmitted to all other participants in the collaborative browsing session so that they can retrieve the Web content identified by the URL and display it in the appropriate frame.

In step 313, the state of the state machine is set to 0 and the state machine returns to rest. In addition, the monitoring module informs the browser via its API to discard any “late returns” from this page.

If in step 310 it was determined that the URL was not the last URL in the table, processing proceeds to step 315 where the URL's entry is deleted from the table. The state machine then returns to rest.

A third type of event that may occur is that an HTTP request is completed (i.e., an HTTP response is received by the browser), as shown in step 316. The state machine's state is used to determine the next processing step, as shown in step 317. If this response is to an old request from a previously closed page (state=0), it is ignored (step 318). Otherwise (state=1), the pending URL entry for the request is removed (step 319). The state machine then returns to rest. If as a result of deleting the pending URL entry the URL table becomes empty, this indicates that the page has completed with a normal termination and a notification to that effect should subsequently be received via the browser API.

A fourth type of event that may occur is the browser acknowledging that a top-level URL has fully loaded, as shown in step 320. In step 321, the state machine state is set back to 0. In step 322, the pending URL list is reset (i.e., all entries are deleted). The state machine then returns to rest.

A fifth type of event that may occur is that a URL is fully loaded that corresponds to a frame, as shown in step 323. In step 324, a new snapshot of the page's frame structure is taken and compared to the snapshot taken earlier to identify the highest-level frame that has changed. In step 325, the URL from this highest-level frame and its frame identifier are transmitted to all other participants in the collaborative session so that they can retrieve the Web content identified by the URL and display it in the appropriate frame. In step 326, the URL list is reset. In step 327, the state machine state is returned to 0. The state machine then returns to rest.

The preferred embodiment of FIG. 3 includes a variety of features that address problems that arise in connection with collaborative browsing and, in particular, recreating a first user's Web experience for a second user. These features include URL capture, generating a minimum set of necessary instructions for other participants in the collaborative session, distributing these instructions efficiently and quickly to other participants so that there is minimal or no delay in recreating a first participant's Web experience at other participant devices, and dealing with “broken” URLs.

These and other features of the above-described preferred embodiment are summarized in the paragraphs that follow:

1. Immediate delivery of intercepted top-level URLs. As noted above, the browser API preferably notifies the monitoring module before an HTTP request is sent by the browser. The monitoring module uses two pieces of information in the notification: (1) the URL, and (2) the “dispatch interface pointer.” As noted above, the “dispatch interface pointer” is always the same (during the lifetime of a browser instance), if the URL is destined to replace the whole current Web page. When such a top-level URL is detected, all other participants in the collaborative session are notified of the new URL immediately, while the requester is in the process of placing the request. Since most HTTP requests are for Web pages that replace the whole browser screen rather than a frame that covers part of the browser screen, the original requester and the other session participants most often receive the requested Web content at nearly the same time.

2. Analysis of HTTP requests so that only necessary URLs are transmitted to other session participants. When an HTTP request is for a top-level URL, the page returned by the Web site that received the request often includes many additional URLs that are automatically requested by the browser to fill portions of the page. A typical example is when the page being displayed comprises one or more frames. The URL for the content to be displayed in the frame is included in the returned HTML code transmitted by the Web site in response to the top-level URL and the browser automatically sends the URL request for the frame. Since the frames' URLs are requested automatically, it is not necessary to separately pass those to other session participants because the other participants' browsers will automatically request them. The monitoring component uses a two-state mechanism to avoid transmitting these automatically-requested URLs to other session participants. In the preferred embodiment, state 0 indicates that the next received URL must be sent to other session participants. The state is changed to state 1 when a new URL request is received. State 1 indicates that the next received URL need not be sent to other session participants. The state is changed back to state 0 when, for example, the monitoring component is notified by the browser API that the page including all its frames has been populated (document complete notification for the URL).

3. Parameterized timer for “broken URL.” While in state 1, the monitoring component may never receive document completion notification from the browser API if the browser requested a “broken URL.” A “broken URL” is one that when requested does not result in a response from the Web server to which the request is directed. To address this problem, the monitoring component uses timers to help the system return to the 0 state. In particular, while in state 1, a timer is started each time the monitoring component receives notification of a URL request. If a timer for the last URL in the URL table expires, the system state is forced back to state 0. The timer is adjustable and may be set in accordance with the algorithm described above.

4. Identification of the frame in which a page is to be displayed. In order to identify the frame for which the page was requested, the monitoring component examines and records the URLs of each frame before and after the request is completed. The highest-level frame with a changed URL is the URL that is sent to other session participants, together with the frame identifier. In a preferred embodiment, for URL requests that are directed to loading a new page to a frame, the monitoring component waits to send the originally requested URL for the frame until the frame is fully populated (i.e., until the monitoring component receives a document complete notification for the frame) to avoid conflicts.

5. JavaScript in the URL. In some cases, a URL request might contain a JavaScript function call whose execution dynamically generates a URL request. In that case, transmission of the URL to other session participants is delayed until the URL is identified and a document complete notification for the page is received by the monitoring component.

In an alternative embodiment, if the browser API does not provide notification of completed top-level URLs or frames, then a page-loaded condition can be identified using the pending URL list and a timer. In particular, when the pending URL list becomes empty a timer may be started to allow for embedded URL requests that may yet be sent by the browser. Once the timer expires, a page-loaded condition may be assumed.

In an alternative embodiment, the frame from which a URL originated may be determined after the first URL return, rather than waiting until the URL table is empty or the frame is fully loaded as in the preferred embodiment described above. In current browsers, however, it has been found that this alternative embodiment may result in conflicts when analyzing browser structure while the browser is loading.

In alternative embodiments, some or all of the functionality described above in connection with the monitoring module may instead be provided by a device's operating system or by the browser itself. For example, if the browser or an operating system process allows direct identification of URLs entered or selected by the user (as distinguished from URLs automatically requested by the browser) then it is not necessary for the monitoring module to separately determine whether a URL should be sent to other session participants. Similarly, if the browser or an operating system process allows direct identification of the subframe selected by a user, then it is not necessary for the monitoring module to separately determine (e.g., by comparing before and after snapshots) the subframe identifier to be sent to other session participants.

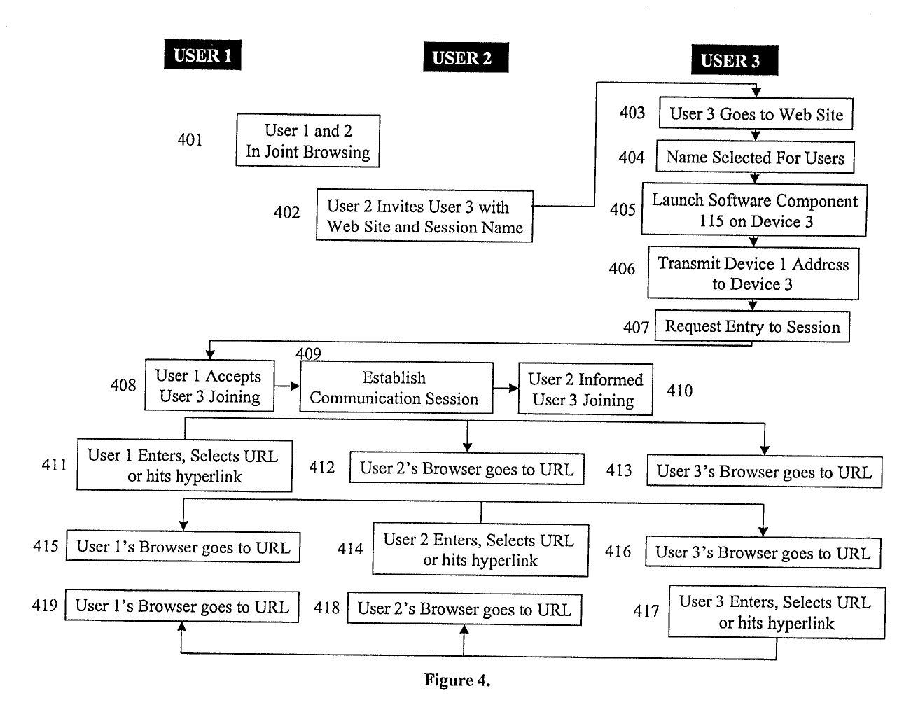

FIG. 4 is a flowchart illustrating a preferred embodiment of system operation when a third participant (referred to hereafter as “user 3”) joins a collaborative browsing session. For purposes of describing FIG. 4, it is assumed that a collaborative browsing session has previously been established between user 1 and user 2, as described above in connection with FIG. 2 (step 401 of FIG. 4). In step 402, user 1 invites user 3 to participate in the collaborative session, and provides user 3 with the session name and URL of server 101. This information may be communicated via any suitable communication means, such as the communication means listed above.

In step 403, user 3 enters server 101's URL into his or her browser. In step 404, a Web page is delivered to user 3's device (referred to hereafter as “device 3”) that includes (1) a first field for user 3 to enter the session name, and (2) a second field for user 3 to enter a name that will be used to identify the user during the session. User 3 enters the session name and selects and enters a username for himself or herself which are then transmitted by device 3 to server 101.

In step 405, server 101 transmits a message that causes a third instance of software component 115 to be launched on device 3. If software component 115 is not already resident on device 3, it is automatically downloaded from server 101 and installed on device 3. In step 406, server 101 transmits the IP address of device 1 to device 3.

In step 407, device 3 transmits a message to device 1 requesting entry into the collaborative browsing session. Device 3 includes its username for the session in this request so that user 1 can determine whether he or she wishes to permit user 3 to join the collaborative session. In step 408, if user 1 is willing to let user 3 join the session, user 1 replies to this request message with his or her own username, so that user 3 can confirm that he or she requested entry to the correct collaborative browsing session. In step 409, device 1 and device 3 establish a communication session that will be used to carry messages between the devices, as described in more detail below. The communication session is preferably established using a TCP/IP or UDP socket or other suitable connection.

In step 410, device 1 forwards the IP address of device 3 and user 3's selected username to all other session participants and the address and usernames of all other session participants to device 3. Communications sessions are then established between each pair of session participants. Alternatively, all communications between any two devices during the collaborative browsing session may be transmitted via device 1.

Joint browsing then proceeds in a manner analogous to that described above in connection with FIG. 2, except that each device informs all other devices participating in the session whenever its user navigates to a new Web resource. In other words, for each user request in steps 411, 414, or 417, the requester's monitoring module notes the HTTP requests created by the device browser and analyzes the sequence to create instructions and URLs to pass to the other devices participating in the session. This information is passed to the other participants' devices which replicate the page for the other participants (steps 412-413, 415-416, and steps 418-419). This process can be repeated as often as desired, with a secondary communication channel (e.g., the communication means listed above) used to resolve social issues regarding conflicts and order. As will again be recognized, server 101 has no involvement or knowledge of the Web content retrieved during the browsing session in this preferred embodiment.

The preferred embodiment of the invention described above enhances an existing communication session between individuals by permitting them to supplement their conversation with a collaborative browsing session. From a user's perspective, the above-described embodiment does not require that he or she learn new programs or abandon existing communication methods (or the communities that have been built around those methods). It also allows each user to maintain his or her anonymity (the user name may be a pseudonym) and privacy in joint browsing. In addition, because server 101 plays a role only in session setup and termination, the system is very scalable and requires only minimal server resources.

The above-described preferred embodiment may be enhanced in a variety of ways to provide additional system functionality and/or improved user experience. These enhancements are now described as additional or further preferred embodiments of the present system.

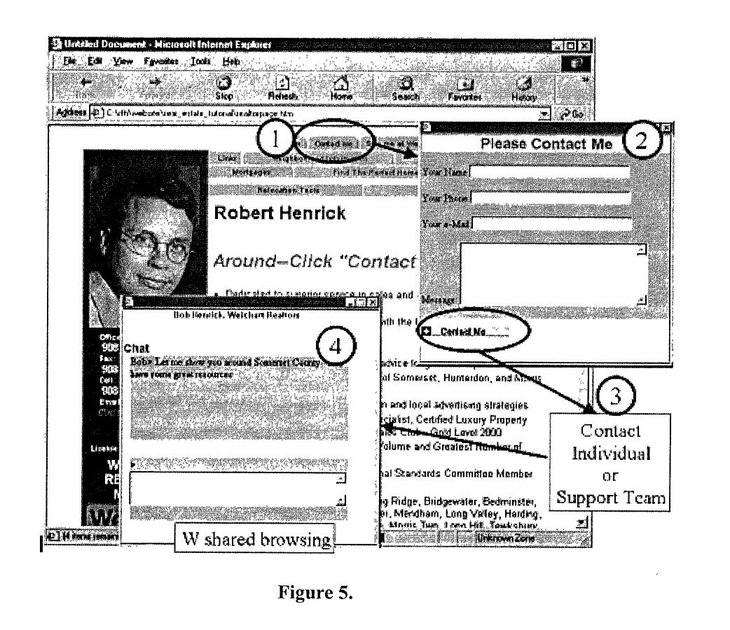

In an additional preferred embodiment, participants 103 may be able to directly initiate or join a collaborative session from a personalized Web page of originating participant 102. For example, as shown in FIG. 5, a personalized Web page of originating participant 102 may be provided with a form that comprises a field in which participant 103 may enter a username and a button that participant 103 may select to request a collaborative session. This simplifies the process for establishing a session. In a preferred embodiment, when a participant 103 requests a collaborative session directly from originating participant 102's personalized Web page, originating participant 102 may be contacted by, for example, instant message, SMS, pager, or telephone, and given the option of establishing the collaborative session or having a message transmitted to participant 103 that originating participant 102 is not currently available for a collaborative browsing session.

Conversely, it is also possible to simplify the process of establishing a collaborative browsing session by integrating the present system into an existing communication application such as instant messaging, Web initiated voice or video conferencing, or a chat room. In that case, it would not be necessary for each participant to communicate a username and session ID to server 101 since such information would be implicit in the established communication program. Moreover, the participants' IP addresses may already be known to one another.

In an additional preferred embodiment, the system's user experience may be enhanced by providing participants 102, 103 with additional displays and control. In particular, a display may be provided to all participants 102, 103 identifying the originator of each Web push to help clarify the conversation. In addition, a standard chat window may be included as a separate window to the browser or as an add-on or appended feature to the browser window to simplify the collaborative browsing process by having chat close to the visual focus. This also lowers costs for users who have initiated the communication by a metered communication method, such as phone or a short message service. A more sophisticated interface may also be provided to allow private chat between particular members of the session.

In an additional preferred embodiment, user interaction may be enhanced by establishing additional communication channels between participants during the collaborative session. These may include a voice call, video call, voice conference call, or video conference call. For example, two users may be using instant messaging to communicate and ask the system to establish a “voice over IP” (VOIP) connection between participants. VOIP functionality may be implemented with a variety of known software packages such as Microsoft Netmeeting™. The system may also establish a file-transfer connection between participants using, for example, a third-party file transfer protocol (FTP) program. If desired, these VOIP and FTP capabilities may be initiated directly by each participant's software component 115 under user command. For example, the software component may be adapted to present an “add voice” button to the user that, when selected, triggers a peer-to-peer, oneon-one conversation between two session participants.

Alternatively, the originating participant may establish an account with a PSTN or hybrid VOIP/PSTN conferencing service. When it is desired to add a voice conference to a collaborative session, each participant device prompts its participant to enter a contact phone number or to choose to be a VOIP participant. For participants joining the conference by PSTN, the conferencing service calls each participant in sequence and adds them to the voice call or asks each participant to call the bridge and enter a code. For participants joining the conference by VOIP, the software component on each client launches a VOIP client, receives the IP address of the conferencing bridge, and then connects to the bridge. Any charges for using the conference bridge and PSTN calls may be added by the service to the originating participant's account.

Enhanced displays may also be provided that allow originating participant 102 to maintain order, manage the collaborative session, and enhance the community that participates in the session. For example, if the collaborative browsing session is used to enhance a broadcast audio lecture, it may desirable during portions of the session to mute all participants except the lecturer. It also may be desirable to allow only the lecturer to lead the browsing (i.e., take the session to a new URL) during these portions of the lecture. An unruly or disruptive participant may be dropped from the session through the same interface, or simply muted for a period of time. In a preferred embodiment, the originating participant may be given control to mute, drop, or stop from leading the browsing, any particular one or more session participants.

In an additional preferred embodiment, originating participant 102 may also be given an option to make the session “public,” i.e., available to any interested party that visits a Web site where the session is listed. The Web site may preferably be maintained by server 101. If desired, originating participant 102 may specify an area of interest (e.g., archeology) and provide a description for the session to be displayed on a Web page served by server 101. Alternatively, originating participant 102 may advertise the session via other media such as newspaper or television ads or via a Web posting. Any member of the public learning of the session may then join the collaborative session by visiting the Web site maintained by server 101, as described above.

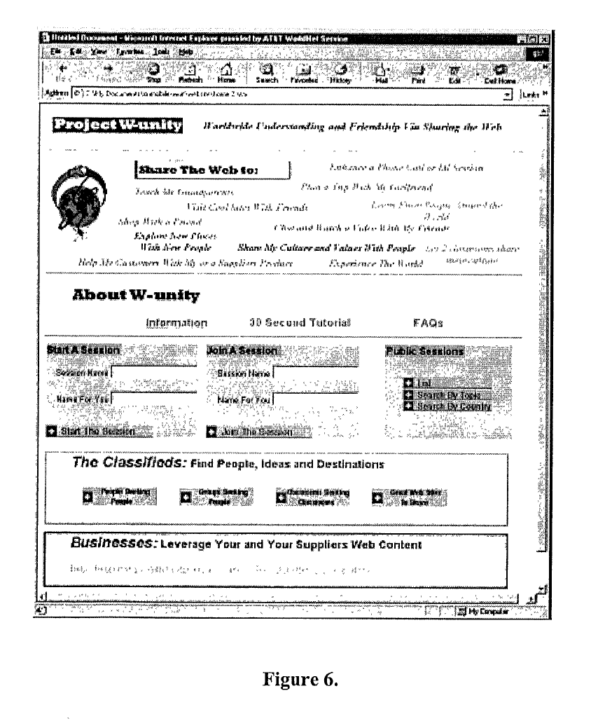

A preferred embodiment of a Web page that may be used to start or join a collaborative browsing session, find “public” sessions that may be joined by any interested party, or post sessions is shown in FIG. 6. As shown in FIG. 6, the page preferably includes fields where a user can enter a session name to join a session as well as links that may be selected in order to obtain more information concerning public sessions that are available. The page preferably allows users to search for such information by topic, group, or environment (e.g., classroom).

The preferred embodiment described above in connection with FIG. 1 illustrates a peer-to-peer connection between users of the same virtual IP Network where there are no barriers to direct communication between participants. For example, all participants may have direct access to the Internet, or all may be behind the firewall of a private corporate network. Even in this latter case, the nature of the role of server 101 in the present system and the ability of clients behind a firewall to access the open Internet using an HTTP request allows the server to be outside the firewall without affecting the functionality described above. If a proxy server connects participants 102, 103 to the Internet, each client's software component may be adapted to pass the internal IP address of its host to originating participant device 102 (rather than server 101), which can in turn pass that address to the other participants' computers.

However, it may often be the case that participants in a collaborative session work for different companies or desire to communicate with friends or customers outside their corporate firewall on the open Internet. Firewalls block incoming messaging, so that a client behind a firewall may not be able to receive a message from a client on the open Internet.

In a preferred embodiment, the present system overcomes this problem by applying a technique known as HTTP spoofing to facilitate collaborative sessions across a firewall. As known in the art, HTTP spoofing is a technique used to facilitate instant messaging across a firewall. In particular, each client in an instant messaging session that is behind a firewall makes a periodic request to an instant-messaging server using HTTP, so that the firewall perceives a Web-transaction request from the client. If there is a message for that client, the instant-messaging server returns the message as an HTTP reply, perceived by the firewall as a Web-server response to the Web-transaction request. If there is no message for that client, no return or a null message is sent.

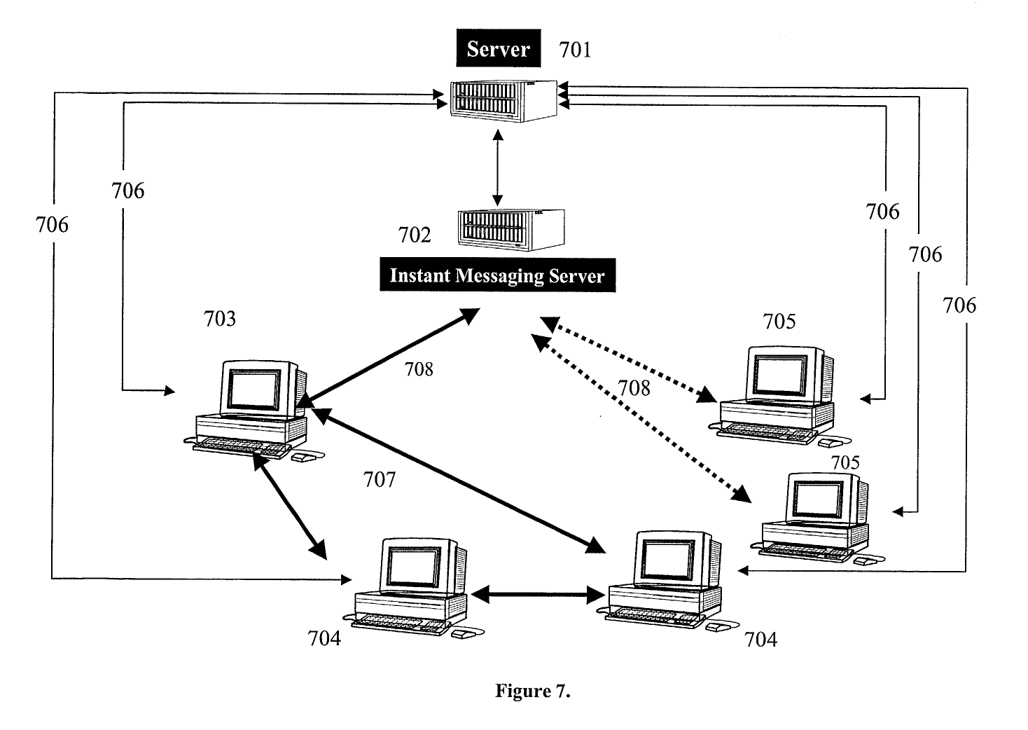

FIG. 7 illustrates a preferred embodiment in which HTTP spoofing is used to facilitate a collaborative browsing session. As shown in FIG. 7, system server 701 is augmented by an additional server 702 that includes firewall-penetration software analogous to the firewall-penetration software common to instant messaging servers. Server 702 may be operated by the same entity that operates server 701 or by a third party. If desired, the third party may establish a user account for each session participant and bill the participants separately or collectively for services provided.

For purposes of this discussion, it is assumed that one set of participant devices 704 are on the same side of the firewall as originating participant device 703. The participants using these devices communicate with the originating participant as previously described. A second set of participant devices 705 may be unable to establish two way communication with originating participant device 703 because they are on opposite sides of a firewall. The software running on server 701 and each participant device behind a firewall is preferably modified to provide collaborative browsing in these situations, as described below.

In particular, when the originating participant establishes the collaborative browsing session with server 701, server 701 attempts to communicate directly with originating participant device 703. If the communication process fails, additional software is sent to originating participant device 703 via a path 706 to provide that device the capability to log onto server 702 and transmit “spoof” HTTP requests to server 702 at regular intervals. Server 701 may then communicate with originating participant device 703 when on opposite sides of the firewall by masking its transmissions as responses to originating participant's HTTP requests.

Similarly, when a joining participant's device 705 fails to establish two-way communications with originating participant device 703 or any other participant device in a collaborative session, participant 705 transmits to server 701 an HTTP spoof message indicating communication failures to a list of participant devices as part of the original HTTP-based session with the server. Additional software is then sent to device 705 via path 706 to provide the joining participant device with spoofing capability via server 702. Communications between participant 705 and originating participant 703 are then conducted via paths 708 and server 702.

In this preferred embodiment, other participant devices 704 on the same side of the firewall as originating participant device 703 preferably maintain direct communication via path 707 with originating-participant device or 703 and other participant devices 704. Originating-participant device 703 facilitates shared browsing with participant devices 705 on the other sides of firewalls by acting as a relay to server 702 and communicating via path 708 to participant devices 705. As will be recognized, this requires both minor modifications to the software running on participant devices 704 and a communication from originating-participant device 703 to devices 704 that message passing will be used. In an alternative embodiment, all participants may use or switch to communicating via server 702 if any one participant is on the other side of a firewall from any other.

In an additional preferred embodiment, the system supports conversations among participants who do not speak the same language. This embodiment may use the same architecture as that described above in connection with FIG. 7, except that server 702 is adapted to provide message translation, rather than (or in addition to) HTTP spoofing. When a first participant wishes to transmit a text message to a second participant who speaks a different language, the first participant's device routes the text message to server 702 which translates the message and forwards the translation to the second participant's device. Each session participant may be permitted to choose a desired language when joining the session.

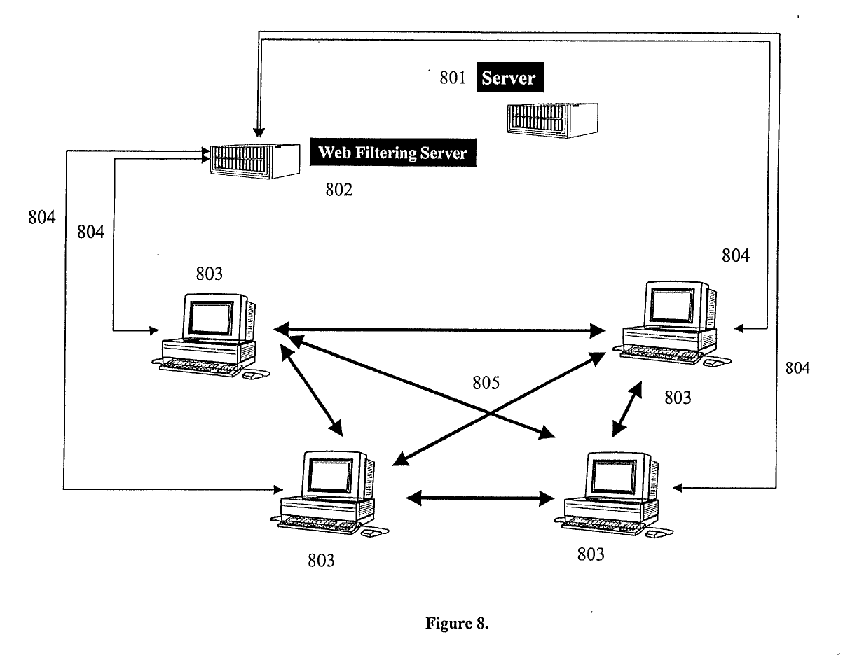

In an additional preferred embodiment, the system may be adapted to limit the types of Web sites that may be viewed by participants. Due to the availability of pornographic or violent Web sites on the Internet, the originating participant, a sponsoring organization of the collaborative browsing session, or the entity that maintains server 101 may want to prevent or limit participant access to such sites. A preferred embodiment for enforcing limits on Website access is now described in connection with FIG. 8.

Each participant device 803 in FIG. 8 is preferably provided with software that is adapted to securely connect to a Web filtering server 802. When a participant attempts to lead the joint session to a particular Web page by entering a URL, the participant's device first transmits the URL to Web filtering server 802 for approval. If the URL is not allowed, server 802 transmits a message to that effect to the participant's device for display to the user. If the URL is allowed, a message confirming that fact is returned to the participant's device. If desired, the message may be digitally signed by server 802 to ensure its veracity. This message is then sent via the standard communication paths 805 to other participant devices 803 participating in the session. The recipient devices preferably validate server 802's digital signature on the message before retrieving the Web content specified by the URL.

A growing use for the broadband Internet is to access streaming video and audio. These media are typically accessed with viewers such as Microsoft's MediaPlayer™. In a preferred embodiment, each participant device may be adapted to synchronize all participants' viewers, allowing a shared experience. In addition, the devices may be adapted to permit a new participant to automatically join a streaming media presentation “already in progress” at the point where the other participants are up to. Moreover, the devices may be adapted to maintain synchronization with the originating participant and/or one or more other participants even as a participant pauses, rewinds, or fast forwards the streaming media presentation.

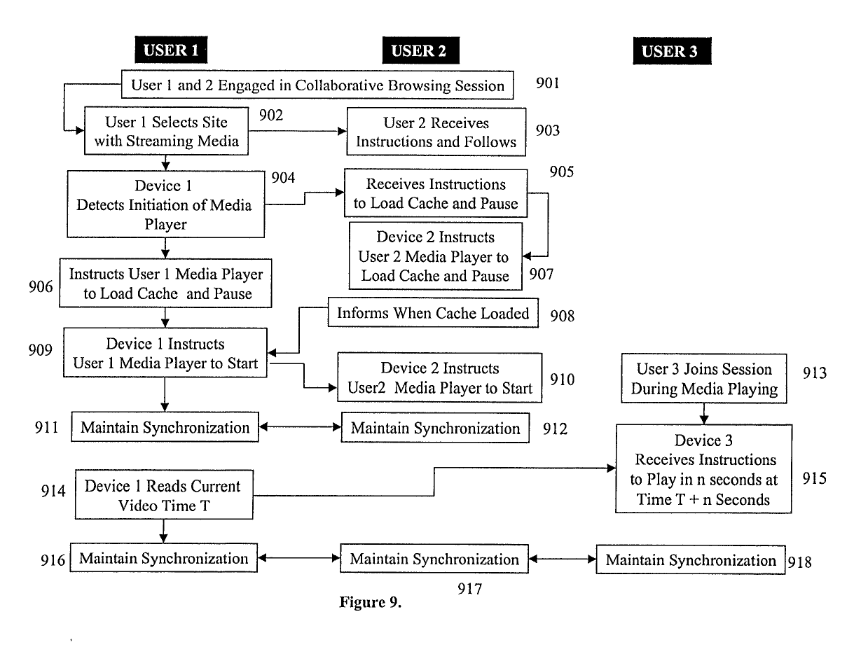

A preferred embodiment of system operation in which synchronized viewing of streaming content is enabled is now described in connection with FIG. 9. For purposes of this description, it is assumed (as illustrated by step 901) that two participants are initially engaged in a collaborative browsing session. An analogous process may be applied with three or more participants. In step 902, one of the participants (designated in the figure for purposes of example as “user 1”) selects a link to a streaming media presentation. In step 903, the second participant (designated in the figure for purposes of example as “user 2”) receives instructions that permit user 2's device to follow user 1 to the same resource, as described above.

In step 904, user 1's device analyzes the Web resource, detects the need for a media player, and notes an initiation request for the media player either by user 1, automatically by user 1's device, or automatically by a Web page associated with the streaming media content. In step 905, user 1's device instructs user 2's device to load its cache for the streaming player and pause. Similarly, in step 906, user 1's device sends a command to user 1's media player to load its cache and pause. In step 907, user 2's device instructs its local media player to load its cache and pause. When user 2's device detects that its media player is paused, it returns a message to user 1's device that it is ready to proceed (step 908).

In step 909, user 1's device starts its media player and instructs user 2's software process to do the same. In step 910, user 2's device starts its media player. The players are thus synchronously initiated. During playing, each software process periodically checks the time of the video stream and compares that with the other process. If the player on one participant's device falls significantly behind another due to pauses caused by intermediate caching, or detects that a participant has stopped, paused, advanced or rewound the stream, that participant device communicates to the other to resynchronize the stream (steps 911-912).

As noted, the system may preferably be adapted to permit a third party to join the streaming media presentation. This embodiment of the invention allows the user to be immediately synchronized with the group viewing the media. In particular, in step 913, a user 3 joins the collaborative browsing session, as described above.

User 3's device is informed that there is a streaming media session in progress and to join the session at a time n seconds in the future. This time corresponds to a relative time in the media stream, T+n, offset from the current relative time of the media stream T. In particular, in step 914, user 1's device detects the time T and, in step 915, passes T+n to user 3's device. User 3's device notes the current absolute time T1 and preloads the cache for relative time in the media stream T+n. At absolute time T1+n seconds, user 3's device starts the stream playing. User 3 is now synchronized with the collaborative viewing session. In steps 916-918, synchronization is maintained between the three devices.

It should be noted that many video and audio sites support different players and different bandwidths for the same media. The preferred embodiment described above does not require each participant to use the same player or bandwidth. Rather, each participant may use whatever player it has resident and may access the stream at any suitable bandwidth.

In a preferred embodiment, the system is also adapted to permit the participants to continue collaborative browsing while streaming media plays. For example, users may listen to the same audio track while continuing to browse Web sites together. In this case, a separate window may be preserved for the media player and a new window used for the collaborative browsing.

Increasingly, many forms of streaming entertainment are not available for free viewing. In a preferred embodiment, the system is adapted to allow a participant to share “pay per view” media with other participants. Many forms of media require subscription or payments for individual viewing or listening, such as music or videos. Other sites require subscriptions for content, such as the Wall Street Journal's™ Web site. By agreement with the owner of the content, a participant may arrange to buy “group viewing” rights from the Internet-content provider. The software component on the purchaser's device may obtain from the content retailer a code or series of codes that may be passed to other participants to allow shared viewing. The software component on each participant's device is modified to receive this code automatically from the originating participant's computer and pass this code to the software retailer's Web site, enabling the other session participants to concurrently view or listen to the content.

In a preferred embodiment, each participant device may be a personal computer running an Internet browser. Alternatively, some or all of the participants may instead use information appliances or wireless devices such as PDAs or mobile phones. When participants to a collaborative session are using different device types, the session preferably navigates to Web sites that support content viewable by each of the different device types. Each device preferably adapts common content from such sites as necessary for viewing on the device.

The above-described embodiments may find application in a large number of commercial, social, and educational contexts. For example, in a preferred embodiment, the participants to a collaborative session may be a real estate broker and one or more potential customers. The real estate broker may lead a session where different houses in a neighborhood are shown to the potential customer(s). At the same time, the broker and customer(s) may engage in a voice or chat session regarding the houses being shown.

In another preferred embodiment, the participants in a collaborative browsing session may be a travel agent and one or more potential customers. The travel agent may lead a session where a variety of vacation options are shown to the potential customer(s). At the same time, the agent and customer(s) may engage in a voice or chat session regarding the vacation possibilities being shown.

In another preferred embodiment, small businesses may use the present system to provide “Internet call center” services for their customers without the expense of specialized equipment or limitations on viewable content. In particular, when a customer calls the center, an employee of the business may establish and lead a collaborative session with the customer and, for example, display to the customer products offered for sale by the business.

In another preferred embodiment, the system may be used to set up “exploratory rooms” where children can visit without the risk of being exposed to pornography or other bad influences. The rooms may be set up, for example, by a children's content provider.

In another preferred embodiment, children in different classrooms separated by thousands of miles may use the present system to establish a collaborative session and use the session to educate each other regarding aspects of their respective cultures. A concurrent voice or chat connection would allow the children in one location to explain the Web content being displayed to the children in the second location.

In another preferred embodiment, grandchildren may establish a collaborative session with their grandparents and tour distant locations together via the Web. The effect of such a collaborative session may be especially symbiotic, because the grandchildren may be able to teach the grandparents about technological resources of the Web and how to use them, while the grandparents may be able to educate the grandchildren about the displayed content (e.g., foreign cities).

In another preferred embodiment, the present system may be used to enhance a broadcast television program by allowing viewers to concurrently participate in a Web-based collaborative browsing session that visits sites related to the program's content. For example, a National Geographic™ program on India may have a companion collaborative browsing session that visits Web sites containing content relating to Indian cultural sites. Alternatively, a CNBC™ program may have a companion collaborative browsing session that visits financial sites with detailed information relating to the concepts and stocks being described in the program. In a preferred embodiment, the collaborative browsing session may include synchronizing the users' TV receivers to the same broadcast channel. If desired, the participants may be provided with an interactive television set that supports Internet browsing and the collaborative browsing session may be conducted using all or a portion of the screen of the interactive television set.

While the invention has been described in conjunction with specific embodiments, it is evident that numerous alternatives, modifications, and variations will be apparent to those skilled in the art in light of the foregoing description.

What is claimed is:

1. A method for enhancing an existing communication session by providing collaborative browsing, comprising:
(a) establishing a collaborative browsing session between a first participant and a second participant, the first participant participating in the collaborative browsing session via a first device and the second participant participating in the collaborative browsing session via a second device;
(b) analyzing HTTP requests made by a browser running on the first device to create a set of instructions for duplicating the first participant's browsing experience for the second participant;
(c) transmitting the set of instructions from the first device to the second device; and
(d) using the received set of instructions to duplicate the first participant's browsing experience for the second participant.

2. The method of claim 1, wherein the collaborative browsing session is established by a server that implements a session-setup procedure.

3. The method of claim 2, wherein session-setup procedure comprises the steps of:
transmitting a message from the first device to the server requesting establishment of a collaborative browsing session, the message specifying a session name and a username for the first participant;
initiating software on the first device adapted to facilitate collaborative browsing;
transmitting a message from the first participant to the second participant, the message including the session name;
transmitting a message from the second device to the server, the message including the session name and specifying a username for the second participant;
initiating software on the second device adapted to facilitate collaborative browsing;
transmitting a message to the second device, the message including an IP address for the first device;
transmitting a message from the second device to the first device, the message including the second participant's username;
accepting by the first participant the presence of the second participant in the collaborative browsing session;
establishing a communication session between the first device and the second device.

4. The method of claim 3, wherein the software necessary to implement steps (b) and (c) is downloaded to the first device if not already resident on that device at the time of the request to establish a collaborative browsing session.

5. The method of claim 3, wherein establishing the communication session comprises establishing a TCP/IP or UDP socket.

6. The method of claim 1, further comprising:
analyzing HTTP requests made by a browser running on the second device to create a set of instructions for duplicating the second participant's browsing experience for the first participant;
transmitting the set of instructions from the second device to the first device;
using the received set of instructions to duplicate the second participant's browsing experience for the first participant.

7. The method of claim 1, wherein a third participant joins the collaborative browsing session, the third participant participating in the collaborative browsing session via a third device, and further comprising the steps of:
transmitting the set of instructions from the first device to the third device;
using the received set of instructions to duplicate the first participant's browsing experience for the third participant.

8. The method of claim 7, wherein the second participant is informed when the third participant joins the session.

9. The method of claim 7, further comprising the steps of:
analyzing HTTP requests made by a browser running on the third device to create a set of instructions for duplicating the third participant's browsing experience for the first and second participants;
transmitting the set of instructions from the third device to the first and second devices;
using the received set of instructions to duplicate the third participant's browsing experience for the first and second participants.

10. The method of claim 1, wherein a participant can create a joint or private chat session with another participant.

11. The method of claim 1, wherein a display is presented to each participant indicating the device from which an HTTP request originated that resulted in a particular aspect of the browsing experience.

12. The method of claim 1, wherein the first participant has a dedicated Web page from which a participant may initiate or join a collaborative session.

13. The method of claim 1, wherein a chat window is provided to allow the participants to communicate in real time as part of the collaborative browsing session.

14. The method of claim 1, wherein a file transfer program is provided to facilitate transferring files between participants during the collaborative browsing session.

15. The method of claim 1, wherein, at a participant's request, a voice over IP program is initiated that adds real-time voice or video to the collaborative browsing session.

16. The method of claim 1, wherein, at a participant's request, an application sharing program is initiated during the collaborative browsing session.

17. The method of claim 1, wherein the first participant is provided with control of the participation capabilities of one or more other participants.

18. The method of claim 17, wherein the control includes having control to mute one or more participants in the collaborative browsing session.

19. The method of claim 17, wherein the control includes having control to stop one or more participants from leading the collaborative browsing session.

20. The method of claim 17, wherein the control includes having control to drop one or more participants from the collaborative browsing session.

21. The method of claim 1, wherein the first participant designates the session public and specifies a topic for the session, and wherein other participants find and join the session by going to a Web site.

22. The method of claim 1, wherein a media stream is encountered as part of a collaborative browsing session, and wherein media players of all participants are synchronized to the same relative time in the media stream.

23. The method of claim 22, wherein the media stream is video, audio, or animation.

24. The method of claim 22, wherein the media stream on the media players of all participants remain synchronized as one or more participants play, pause, rewind, or fast forward the media stream.

25. The method of claim 22, wherein a participant joining a session automatically joins the media stream at the same point in the media stream currently being played to other session participants.

26. The method of claim 1, wherein one of the participants is behind a firewall, and the other participant is not behind that firewall.

27. The method of claim 26, wherein the participant behind the firewall transmits an HTTP request to a second server, and receives a message from the other participant that is routed via the second server and perceived by the firewall as a response to the HTTP request.

28. The method of claim 1, wherein a language-translation server enables multi-lingual collaborative browsing for participants speaking different languages.

29. The method of claim 1, wherein a URL-filtering server is used to block objectionable sites from the collaborative browsing session.

30. The method of claim 1, wherein software is provided that is adapted to permit set up of a voice call, video call, voice conference call, or video conference call between participants during the collaborative browsing session.

31. The method of claim 1, wherein a pay-per-view media stream is shared by the participants by agreement with the media owner for one user to pay and then provide temporary viewing of the media stream to one or more other participants.

32. The method of claim 1, wherein one or more of the devices is a computer.

33. The method of claim 1, wherein one or more of the devices is a mobile cellphone.

34. The method of claim 1, wherein one or more of the devices is a PDA.

35. The method of claim 1, wherein one or more of the devices is an interactive television set and the synchronization of media includes the broadcast TV content.

36. The method of claim 1, wherein the first device and second device are different types of devices, and wherein the collaborative browsing session navigates to Web sites that support content viewable by the different types of devices.

37. The method of claim 36, wherein the devices adapt common content at the Web sites for viewing.

38. The method of claim 1, wherein step (b) is performed by software running on the first device.

39. The method of claim 38, wherein the software receives HTTP-request notifications from a browser running on the first device via the browser API.

40. The method of claim 38, wherein the software comprises a state machine.

41. The method of claim 1, further comprising:
receiving notification of an HTTP request;
determining whether or not it is necessary to transmit a URL that is the subject of the HTTP request to the second device in order for the second device to recreate for the second participant the first participant's browsing experience;
if it is necessary to transmit the URL that is the subject of the HTTP request to the second device in order for the second device to recreate for the second participant the first participant's browsing experience, then transmitting the URL that is the subject of the HTTP request to the second device.

42. The method of claim 1, further comprising:
determining whether a URL that is the subject of an HTTP request is a top-level URL for a Web page; and
if the URL that is the subject of the HTTP request is a top-level URL for a Web page, transmitting the requested URL immediately to the second device.

43. The method of claim 42, wherein the step of determining whether a URL that is the subject of an HTTP request is a top-level URL for a Web page comprises examining a dispatch interface pointer included with an HTTP-request notification.

44. The method of claim 1, further comprising:
determining whether a URL that is the subject of an HTTP request is a top-level URL for a Web page; and
if the URL that is the subject of the HTTP request is not a top-level URL, then:
identifying a highest-level frame in the browser display that has a new URL;
transmitting the new URL and an identifier for the highest-level frame to the second device.

45. The method of claim 44, wherein the step of identifying is performed upon receipt of a frame-fully-loaded notification.

46. The method of claim 44, wherein the step of identifying is performed upon expiration of a timer.

47. The method of claim 46, wherein the timer is set as a function of the average time and standard deviation to complete an HTTP request.

48. The method of claim 44, wherein the step of identifying comprises:
recording the URLs of each frame in the browser's display before the HTTP request is completed;
recording the URLs of each frame in the browser's display after the HTTP request is completed; and
comparing results of the first recording to results of the second recording.

49. A system for providing collaborative browsing, comprising:
a) a packet network;
b) a first device connected to the packet network, the first device being in the possession of a first participant;
c) a second device connected to the packet network, the second device being in the possession of a second participant, the first and second participants being in communication; and
d) the first device comprising software adapted to analyze HTTP requests made by a browser running on the first device to create a set of instructions for duplicating the first participant's browsing experience for the second participant.

50. The system of claim 49, wherein the second device comprises software adapted to analyze HTTP requests made by a browser running on the second device to create a set of instructions for duplicating the second participant's browsing experience for the first participant.

51. The system of claim 49, further comprising:
a third device connected to the packet network, the third device being in the possession of a third participant;
the third device comprising software adapted to analyze HTTP requests made by a browser running on the third device to create a set of instructions for duplicating the third participant's browsing experience for the first and second participants.

52. The system of claim 49, further comprising a server adapted to establish a collaborative browsing session at the request of one of the participants.

53. The system of claim 52, wherein a session name for the collaborative browsing session is passed to the second participant from the first participant via a communications means external to the packet network.

54. The system of claim 49, wherein the apparatus of claim 49 is incorporated into an instant messaging program to enhance an instant messaging session.

55. The system of claim 49, wherein the apparatus of claim 49 is incorporated into a Web initiated voice or video conferencing system to enhance a conferencing session.

56. The system of claim 49, wherein the apparatus of claim 49 is incorporated into a mobile short message system utilized by mobile devices to enhance a conversation conducted using the short message system.

57. The system of claim 49, further comprising a second server adapted to transmit messages to a participant behind a firewall that are perceived by the participant as responses to HTTP requests.

58. The system of claim 49, further comprising a language-translation server that enables multi-lingual collaborative browsing for participants speaking different languages.

59. The system of claim 49, further comprising a third server adapted to approve or disapprove particular Web content for use during a collaborative browsing session.

60. The system of claim 49, further compromising software adapted to permit set up of a voice call, video call, voice conference call, or video conference call between participants.

61. The system of claim 49, wherein one or more of the devices is a computer.

62. The system of claim 49, wherein one or more of the devices is a mobile cellphone.

63. The system of claim 49, wherein one or more of the devices is a PDA.

64. The system of claim 49, wherein one or more of the devices is an interactive television set and the synchronization of media includes the broadcast TV content.

65. The system of claim 49, wherein the first device and second device are different types of devices, and wherein the collaborative browsing session navigates to Web sites that support content viewable by the different types of devices.

66. The system of claim 65, wherein the devices adapt common content at the Web sites for viewing.
